(19) United States
(12) Patent Application Publication
(10) Pub. No.: US 2004/0035791 A1
(43) Pub. Date: Feb. 26, 2004

(54) Formation of hydrophilic sites in partially silylated micelle templated silica

(76) Inventors: Laurent Bonneviot, Lyon (FR); Alireza Badiei, Tehran (IR); Nicolas Crowther, Oullins (FR)

Correspondence Address: FOLEY AND LARDNER, SUITE 500, 3000 K STREET NW, WASHINGTON, DC, 20007, US

(21) Appl. No.: 10/344,702

(22) PCT Filed: Aug. 17, 2001
(86) PCT No.: PCT/CA01/01161

(30) Foreign Application Priority Data
Aug. 25, 2000 (CA) 2,317,056

(51) Int. Cl. B01D 11/00

(52) U.S. Cl. 210/638; 210/639; 423/335

(57) ABSTRACT

The invention relates to a method of preparing a partially silylated silica having at a surface thereof hydrophilic sites defined by non-silylated hydroxyl groups. The method of the invention comprises the steps of (a) providing a micelle templated silica having at a surface thereof surfactant-protected hydroxyl groups and unprotected hydroxyl groups; (b) treating the micelle templated silica with a base-generating silylating agent to silylate the unprotected hydroxyl groups and thereby obtain a partially silylated micelle templated silica; and (c) treating the partially silylated micelle templated silica with an acid to displace the surfactant, thereby obtaining a partially silylated silica having at the surface thereof hydrophilic sites defined by non-silylated hydroxyl groups. Such a partially silyalated silica having hydrophilic sites is useful as a catalyst support and for ion exchange in chromatography.

### TECHNICAL FIELD

The present invention pertains to improvements in the field of micelle templated silica. More particularly, the invention relates to the formation of hydrophilic sites in a partially silylated micelle templated silica.

### BACKGROUND ART

The large pore of micelle templated silica in comparison to that of zeolites provides novel opportunities in the field of molecular sieves not only for the scope of treating bulkier molecules, but also for the variety of chemical modifications of their internal surface. Taking advantages of such a versatility, researchers have tried to tailor tune their acid-base, their hydrophobicity and their catalytic properties envisionning many different applications in fields as different as adsorbents, separation and acid catalysis. In this context, the stability of micelle templated silica is an important consideration. Originally, their hydrothermal stability was poor according to the loss of their mesoporous structure in acid or alkaline solution. Several methods have been proposed to increase the stability of mesoporous materials, including synthesis of materials with thicker pore walls, silylation, stabilization by tetralkylammonium and salt effect. New avenues explored recently the preparation of templated mesostructured materials having an organic core with an inorganic shell using (EtO)₃-Si-RSi(OEt)₃ type of precursors, in which R is an ethylene, phenyl or thiophene group. However, the organic functions are located inside the walls where again accessibility restriction is expected.

### DISCLOSURE OF THE INVENTION

The present invention provides a method of forming hydrophilic sites of very small size within the channels of micelle templated silica.

In accordance with the invention, there is thus provided a method of preparing a partially silylated silica having at a surface thereof hydrophilic sites defined by non-silylated hydroxyl groups. The method of the invention comprises the steps of:

a) providing a micelle templated silica having at a surface thereof surfactant-protected hydroxyl groups and unprotected hydroxyl groups;

b) treating the micelle templated silica with a base-generating silylating agent to silylate the unprotected hydroxyl groups and thereby obtain a partially silylated micelle templated silica; and

c) treating the partially silylated micelle templated silica with an acid to displace the surfactant, thereby obtaining a partially silylated silica having at the surface thereof hydrophilic sites defined by non-silylated hydroxyl groups.

The present invention also provides, in another aspect thereof, a partially silylated silica having at a surface thereof hydrophilic sites defined by non-silylated hydroxyl groups.

As used herein, the expression “base-generating silylating agent” refers to a silylating agent which is capable of forming a base as a byproduct of the silylation. Applicant has found quite unexpectedly that such a base does not displace the templating surfactant so that the surfactant-protected hydroxyl groups remain protected during the silylation and a partial silylation of the micelle templated silica can thus be achieved. In contrast, the acid formed as a by-product during silylation by acid-generating silylating agents such as, for example, chlorotrimethylsilane displaces the templating surfactant, leading to a complete silylation and to a very hydrophobic surface. Once the micelle templated silica has been partially silylated, it can thereafter be treated with an acid to displace the templating surfactant and thereby obtain the desired partially silylated silica having hydrophilic sites at the surface thereof.

### MODES FOR CARRYING OUT THE INVENTION

Examples of suitable base-generating silylating agents which may be used for effecting the partial silylation include hexamethyldisilazane, di-n-butyltetramethyldisilazane, 1,3-divinyl-1,3-diphenyl-1,3-dimethyldisilazane, hexamethyldisiloxane, 1,3-diallyltetramethyldisiloxane, 1,3-divinyl-1,3-diphenyl-1,3-dimethyldisiloxane, triphenylsilanol, diphenylsilanediol, bis(cyanopropyl)tetramethyldisiloxane, N,O-bis(trimethylsilyl)acetamide and N,O-bis(trimethylsilyl)trifluoroacetamide. Hexamethyldisilazane is particularly preferred.

According to a preferred embodiment of the invention, step (b) is carried out by treating the micelle templated silica under reflux at a temperature of about 25°-150° C. in a solution of the silylating agent in a non-polar solvent. The solvent used for dissolving the silylating agent must be non-polar in order to prevent a dissolution of the templating surfactant. Examples of suitable non-polar solvents which may be used include toluene, benzene, cyclohexane, n-hexane, trichloromethanie and diethylether. Toluene is particularly preferred.

According to another preferred embodiment, step (b) is carried out by treating the micelle templated silica in a fluidized bed under a flow of a inert gas saturated at about 50°-150° C. with the silylating agent. Nitrogen is preferably used as inert gas.

According to a further preferred embodiment, step (c) is carried out by washing the partially silylated micelle templated surfactant with an acid in admixture with a polar solvent such as ethanol. Hydrochloric acid is preferably used.

The surfactant used for protecting the hydroxyl groups at the surface of the silica is preferably a quaternary ammonium salt. Examples of suitable quaternary ammonium salts which may be used include tetramethylammonium salts, cetyltrimethylammonium salts and benzyltrimethylammonium salts. Cetyltrimethylammonium bromide is particularly preferred. It is also possible to use a quaternary phosphonium salt such as, for example, dodecyltriphenylphosphonium bromide.

The partially silylated silica having hydrophilic sites and obtained by the method according to the invention is useful as a catalyst support and for ion exchange in chromatography. Typically, the hydrophilic sites represent about 35% to about 55% of the surface of the silica. The hydroxyl groups of the partially silylated silica are preferably silylated by trimethylsilyl groups. Silylation and particularly trimethylsilylation enhance the mechanical stability of the silica. The hydrophilic sites, on the other hand, are available for further surface modifications.

The following non-limiting examples illustrate the invention.

Preparation of Micelle Templated Silica

Pure hexagonal micelle templated silica was prepared from a gel of molar composition: 1.00 SiO₂, 0.86 Na₂O, 0.44 (TMA)₂O, 0.30 CTMABr, 63.3 H₂O (TMA=tetramethylammonium; CTMABr=cetyltrimethylammonium bromide). A solution of cetyltrimethylammonium bromide was slowly added to a clear gel containing fumed silica (Cab-O-Sil), sodium silicate and TMA-silicate with vigorous stirring at room temperature. The resulting gel was transferred into a Teflon-lined autoclave (1 litre autoclave for about 60 g of silica) and maintained for 24 h at 130° C. The resulting powder was filtered, washed with distilled water and dried in air. To improve the long range order of the as-synthesized material, the resulting solid was treated in 600 ml of water per 60 g of solid into a Teflon-lined autoclave for 24 h at 130° C. Then, this powder was filtered, washed with distilled water, and dried in air.

### EXAMPLE 1

The micelle templated silica (1.0 g) as prepared above was treated under reflux in a solution of hexamethyldisilazane in toluene and allowed to react for 2 h at 110° C. The silylated product was washed with ethanol and dried in air. The solid (250 mg) was added to a mixture of 100 ml of ethanol and 10 ml of 0.1 N HCl and stirred for two hours. Under these conditions, the cetyltrimethylammonium groups were removed from the solid. The acid washed material was filtered and washed with ethanol. The excess of HCT was titrated with 0.1 N NaOH.

### EXAMPLE 2

The micelle templated silica (1.2 g) as prepared above was treated in a fluidized bed under a gas flow (15 cm³/min.) of nitrogen saturated at 130° C. with hexamethyldisilazane; 5 ml of the latter were consumed. The silylated product was washed with ethanol and dried in air. The solid (250 mg) was added to a mixture of 100 ml of ethanol and 10 ml of 0.1 N HCl and stirred for two hours. Under these conditions, the cetyltrimethylammonium groups were removed from the solid. The acid washed material was filtered and washed with ethanol. The excess of HCl was titrated with 0.1 N NaOH.

### EXAMPLE 3 (Comparative)

The micelle templated silica (1.0 g) was treated overnight under reflux at 100° C. in 20 ml of a 1:1 mixture of chlorotrimethylsilane and hexamethyldisiloxane. The silylated product was washed with ethanol and dried in air. The solid (250 mg) was added to a mixture of 100 ml of ethanol and 10 ml of 0.1 N HCl and stirred for two hours. Under these conditions, the cetyltrimethylammonium groups were removed from the solid. The acid washed material was filtered and washed with ethanol. The excess of HCl was titrated with 0.1 N NaOH.

The silylated and acid washed materials obtained in Examples 1, 2 and 3 were all tested for their ion exchange capacity. A chloride salt of the (Co(en)₂Cl₂]⁺ complex was cation exchanged at room temperature for one hour. Typically, for 200 mg of the silylated and acid washed product, 3 ml of concentrated ammonia (30%) were added to a 50 ml solution of cobalt complex (2.8×10⁻³ M) in a 73:27 water:ethanol mixture. Except for the fully silylated silica obtained in Example 3, which remained white, the partially silylated solids obtained in Examples 1 and 2 took up the coloration of the cobalt complex during ion exchange at pH 10.

The SiO⁻/Si ratio was also determined by acid-base titration in a non-aqueous solvent such as ethanol. The SiO⁻/Si ratio decreases from 17.8 to 13.8, 9.4 and 0 for the micelle templated silica to the silylated forms obtained in Examples 1, 2 and 3, respectively.

The tethered trimethylsilane groups are characterized by characteristic IR bands at 1250, 850, 750 cm⁻¹. The deepness of silylation measured by SiO⁻ titrations was quantitatively confirmed by ¹³C and ²⁹Si MAS-NMR spectroscopy.

The silylation deepness calculated in terms of the number of trimethylsilyl groups per nm² was obtained from the elemental analysis of carbon performed on the silylated and acid washed materials of Examples 1, 2 and 3, according to the following equation:

$$S = [ \frac{( \% C )}{50 - ( \% C )} ] \frac{{N}_{A}}{( TRMS ) ( {S}_{MTS} )} \times {10}^{- 18}$$

where % C is the content of carbon reported in weight percentage, N_{A} is Avogadro's number, TRMS is the effective molecular weight of the trimethylsilyl groups and S_{MTS} is the surface area of non-silylated material (1060 m²/g in the present experiment). The results are reported in the following Table.

TABLE

| Solid | S | TRMS |
|---|---|---|
| Tested | TRMS/nm² | coverage (%) |
| Ex. 1 | 1.1 | 42 |
| Ex. 2 | 1.6 | 61 |
| Ex. 3 | 2.6 | 100 |

1. A method of preparing a partially silylated silica having at a surface thereof hydrophilic sites defined by non-silylated hydroxyl groups, comprising the steps of:
a) providing a micelle templated silica having at a surface thereof surfactant-protected hydroxyl groups and unprotected hydroxyl groups;
b) treating said micelle templated silica with a base-generating silylating agent to silylate the unprotected hydroxyl groups and thereby obtain a partially silylated micelle templated silica; and
c) treating said partially silylated micelle templated silica with an acid to displace the surfactant, thereby obtaining a partially silylated silica having at the surface thereof hydrophilic sites defined by non-silylated hydroxyl groups.

2. A method according to claim 1, wherein said silylating agent is selected from the group consisting of hexamethyldisilazane, di-n-butyltetramethyldisilazane, 1,3-divinyl-1,3-diphenyl-1,3-dimethyldisilazane, hexamethyldisiloxane, 1,3-diallyltetramethyldisiloxane, 1,3-divinyl-1,3-diphenyl-1,3-dimethyldisiloxane, triphenylsilanol, diphenylsilanediol, bis(cyanopropyl)tetramethyldisiloxane, N,O-bis(trimethylsilyl)acetamide and N,O-bis(trimethylsilyl)trifluoroacetamide.

3. A method according to claim 2, wherein said silylating agent is hexamethyldisilazane.

4. A method according to any one of claims 1 to 3, wherein step (b) is carried out by treating said micelle templated silica under reflux at a temperature of about 25°-150° C. in a solution of said silylating agent in a non-polar solvent.

5. A method according to claim 4, wherein said non-polar solvent is selected from the group consisting of toluene, benzene, cyclohexane, n-hexane, trichloromethane and diethylether.

6. A method according to claim 5, wherein said non-polar solvent is toluene.

7. A method according to any one of claims 1 to 3, wherein step (b) is carried out by treating said micelle templated silica in a fluidized bed under a flow of an inert gas saturated at about 50°-150° C. with said silylating agent.

8. A method according to claim 7, wherein said inert gas is nitrogen.

9. A method according to any one of claims 1 to 8, wherein step (c) is carried out by washing said partially silylated micelle templated silica with said acid in admixture with a polar solvent.

10. A method according to claim 9, wherein said acid is hydrochloric acid and said polar solvent is ethanol.

11. A method according to any one of claims 1 to 10, wherein the surfactant-protected hydroxyl groups are protected by quaternary ammonium groups.

12. A method according to claim 11, wherein said quaternary ammonium groups are tetramethylammonium, cetyltrimethylammonium or benzyltrimethylammonium groups.

13. A method according to claim 12, wherein said quaternary ammonium groups are cetyltrimethylammonium groups.

14. A method according to any one of claims 1 to 10, wherein the surfactant-protected hydroxyl groups are protected by quaternary phosphonium groups.

15. A method according to claim 14, wherein said quaternary phosphonium are dodecyltriphenylphosphonium groups.

16. A partially silylated silica having at a surface thereof hydrophilic sites defined by non-silylated hydroxyl groups.

17. A silica according to claim 16, wherein the hydrophilic sites represent about 35% to about 55% of said surface.

18. A silica according to claim 16 or 17, wherein hydroxyl groups are silyated by trimethylsilyl groups.
